(19) United States
(12) Patent Application Publication
(10) Pub. No.: US 2003/0002386 A1
(43) Pub. Date: Jan. 2, 2003

(54) Combined chassis and mixer apparatus

(76) Inventor: William S. Knight, Brodhead, WI (US)

Correspondence Address: DAVID J. ARCHER, 9790 FOREST PRESERVE RD., DURAND, IL, 61024, US

(21) Appl. No.: 09/896,077

(22) Filed: Jun. 30, 2001

(51) Int. Cl. B01F 7/24

(52) U.S. Cl. 366/153.3; 366/156.1; 366/603

(57) ABSTRACT

A combined chassis and mixer apparatus is disclosed for mixing livestock feed. The apparatus includes a chassis having a front and a rearward end. The chassis includes an operator station, a motor and a gearbox driven by the motor. The chassis also includes at least one pair of drive wheels for moving the chassis. The drive wheels are connected to the gearbox for selectively moving the chassis in a first direction from the rearward end towards the front end and in a second direction from the front end towards the rearward end of the chassis. An extension framework has a first and a second end, the first end of the extension extending from the chassis in the second direction. A mixer container is supported by the extension such that the container is disposed between the chassis and the second end of the extension. Additionally, at least one steerable wheel is rotatably connected to the second end of the extension so that the second end of the extension is disposed between the container and the steerable wheel such that location and positioning of the mixer container for dispensing the livestock feed is enhanced.

### BACKGROUND OF THE INVENTION

1. Field of the Invention

The present invention relates to a combined chassis and mixer apparatus for mixing livestock feed. More specifically, the present invention relates to a combined chassis and mixer apparatus for mixing livestock feed in which location and positioning of the mixer container for dispensing the livestock feed is enhanced.

2. Information Disclosure Statement

Mixers are primarily used for mixing various foods for subsequent distribution to animal feed troughs. However, prior art mixers include a drawbar and hitch for connection to a tractor The tractor includes a power take off (PTO) and a driveline must be connected between the tractor and the mixer in order to rotate a mixing auger within the mixer container. When the feed has been mixed, the tractor tows the mixer to the animal trough where a portion of the feed is discharged through an outlet in the mixer container for feeding the cattle.

Although U.S. Pat. No. 5,782,559 to Neier et al teaches a self-propelled material mixer, the prior art arrangements suffer from the following drawbacks: In the Neier et al arrangement described in the '559 patent, the operator is located at the back which is a disadvantage.

The combined tractor and mixer according to the present invention has the following advantages over the more conventional mixers towed by a tractor. First, the combined tractor and mixer of the present invention is shorter. Second, the combined tractor and mixer is easier to maneuver. Third, the combined tractor and mixer according to the present invention is easier to backup. Fourth, the combined tractor and mixer has better traction when compared with the mixers towed by a tractor. Also, with the towed mixers, the mixer must be hitched and unhitched to the tractor when mixing is to be carried out.

The combined chassis and mixer of the present invention overcomes all of the aforementioned problems associated with the prior art arrangements by the provision of a combined apparatus which enables an operator thereof to accurately locate the outlet of the mixer in close proximity to the animal feed trough.

Therefore, it is a primary feature of the present invention to provide a combined chassis and mixer which overcomes the problems associated with the prior art proposals and which makes a considerable contribution to the art of mixing and distributing animal feed.

Another feature of the present invention is the provision of a combined chassis and mixer apparatus in which the mixer is permanently connected in driven relationship with the chassis.

Other features and advantages of the present invention will be readily apparent to those skilled in the art by a consideration of the detailed description of a preferred embodiment of the present invention contained herein.

### SUMMARY OF THE INVENTION

The present invention relates to a combined chassis and mixer apparatus for mixing livestock feed. The apparatus includes a chassis having a front and a rearward end. The chassis includes an operator station, a motor and a gearbox driven by the motor. The chassis also includes at least one pair of drive wheels for moving the chassis. The drive wheels are connected to the gearbox for selectively moving the chassis in a first direction from the rearward end towards the front end and in a second direction from the front end towards the rearward end of the chassis. An extension framework has a first and a second end, the first end of the extension extending from the chassis in the second direction. A mixer container is supported by the extension such that the container is disposed between the chassis and the second end of the extension. Additionally, a steerable wheel is rotatably connected to the second end of the extension so that the second end of the extension is disposed between the container and the steerable wheel such that location and positioning of the mixer container for dispensing the livestock feed is enhanced.

In a more specific embodiment of the present invention, the drive wheels have a diameter which is greater than a diameter of the steerable wheel. Also, the first end of the extension is rigidly secured to the rearward end of the chassis and the mixer container is secured to the extension.

Additionally, the mixer container includes a base which defines a peripheral edge. A wall extends away from the peripheral edge, the base and the wall defining therebetween an enclosure for the reception therein of the livestock feed. An auger is rotatably disposed within the enclosure such that when the feed is disposed within the enclosure, rotation of the auger mixes the livestock feed.

Also, a power take off extends between the gearbox and the auger for rotating the auger and the wall defines a discharge outlet for the discharge therethrough of mixed livestock feed.

Many modifications and variations of the present invention will be readily apparent to those skilled in the art by a consideration of the detailed description contained hereinafter taken in conjunction with the annexed drawings showing a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a combined chassis and mixer apparatus according to the present invention; and

FIG. 2 is a top plan view of the apparatus shown in FIG. 1.

Similar reference characters refer to similar parts throughout the views of the drawings.

### DETAILED DESCRIPTION OF THE DRAWINGS

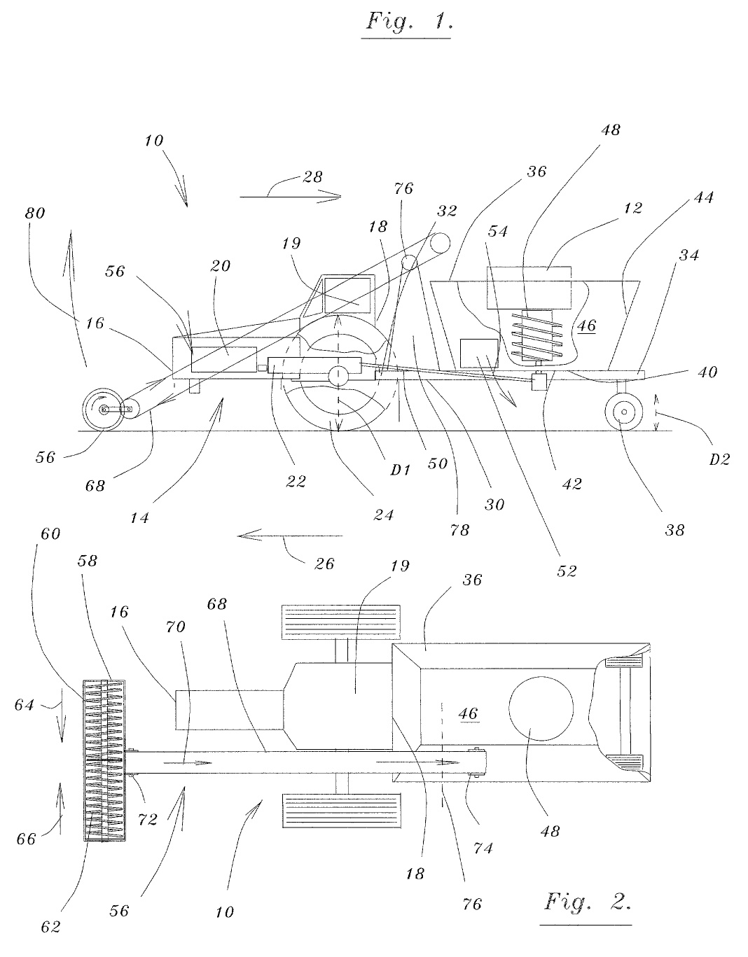

FIG. 1 is a side elevational view of a combined chassis and mixer apparatus generally designated 10 according to the present invention for mixing livestock feed 12. The apparatus 10 includes a chassis 14 having a front and a rearward end 16 and 18 respectively. The chassis 14 includes an operator station 19, a motor 20 and a gearbox 22 driven by the motor 20. The chassis 14 also includes at least one pair of drive wheels 24 for moving the chassis 14. The drive wheels 24 are connected to the gearbox 22 for selectively moving the chassis 14 in a first direction as indicated by the arrow 26 from the rearward end 18 towards the front end 16 and in a second direction as indicated by the arrow 28 from the front end 16 towards the rearward end 18 of the chassis 14. An extension framework 30 has a first and a second end 32 and 34 respectively, the first end 32 of the extension 30 extending from the chassis 14 in the second direction 28. A mixer container 36 is supported by the extension 30 such that the container 36 is disposed between the chassis 14 and the second end 34 of the extension 30. Additionally, a steerable wheel 38 is rotatably connected to the second end 34 of the extension 30 so that the second end 34 of the extension 30 is disposed between the container 36 and the steerable wheel 38 such that location and positioning of the mixer container 36 for dispensing the livestock feed 12 is enhanced.

In a more specific embodiment of the present invention, the drive wheels 24 have a diameter D1 which is greater than a diameter D2 of the steerable wheel 38.

Also, the first end 32 of the extension 30 is rigidly secured to the rearward end 18 of the chassis 14 and the mixer container 36 is secured to the extension 30.

Additionally, the mixer container 36 includes a base 40 which defines a peripheral edge 42. A wall 44 extends away from the peripheral edge 42, the base 40 and the wall 44 defining therebetween an enclosure 46 for the reception therein of the livestock feed 12. An auger 48 is rotatably disposed within the enclosure 46 such that when the feed 12 is disposed within the enclosure 46, rotation of the auger 48 mixes the livestock feed 12.

Also, a power take off (PTO) and driveline 50 extends between the gearbox 22 and the auger 48 for rotating the auger 48 and the wall 44 defines a discharge outlet 52 for the discharge therethrough of mixed livestock feed 12 as indicated by the arrow 54.

Also as shown in FIG. 1, the apparatus 10 includes a self loader arrangement generally designated 56 for collecting and conveying material to the container 36 for mixing thereof.

FIG. 2 is a top plan view of the apparatus 10 shown in FIG. 1. As shown in FIG. 2, the self loader 56 includes a bucket 58 and a first and second auger 60 and 62 respectively. The augers are arranged so that the material is fed in the direction of the arrows 64 and 66 by the augers 60 and 62 respectively. The material is thereafter conveyed by a conveyor belt 68 in a direction as indicated by the arrow 70 so that the material is fed into the container 36. The conveyor belt 68 has a first end 72 disposed adjacent to the bucket 58 and a second end 74 disposed above the container 36. Furthermore, the conveyor 68 is pivoted about an axis 76 disposed between the first and second ends 72 and 74 respectively of the conveyor 68. As shown in FIG. 1, the axis 76 is a pivotal bearing supported by a column 78.

In operation of the apparatus according to the present invention, in order to position the outlet 52 adjacent to an animal feed trough, the gearbox 22 is positioned in reverse gear and the combined apparatus is reversed to the desired location. Drivers towing a trailer know that reversing a towed trailer into a parking space requires considerably more driving skill than reversing an automobile without a trailer into the same parking space. Also, parking an automobile forwardly with or without a trailer is relatively easy. Similarly, in the present invention, the combined chassis and mixer is analogous to driving an automobile without trailer forwardly for parking thereof. Therefore, the unique combined apparatus according to the present invention enhances the ease with which an outlet of the mixer may be located adjacent to an animal feeding trough.

Also, the operator is able alter the elevation of the bucket 56 as indicated by the arrow 80 shown in FIG. 1, so that material can be selectively fed into the container 36 by means of the augers 60 and 62 and by the conveyor 68.

The apparatus according to the present invention provides a compact and maneuverable machine for mixing feed and the like and conveying such mixed feed for distribution thereof.

What is claimed is:

1. A combined chassis and mixer apparatus for mixing livestock feed, said apparatus comprising:
a chassis having a front and a rearward end;
said chassis including:
an operator station;
a motor;
a gearbox driven by said motor;
a pair of drive wheels for moving said chassis, said drive wheels being connected to said gearbox for selectively moving said chassis in a first direction from said rearward end towards said front end and in a second direction from said front end towards said rearward end of said chassis;
an extension framework extending from said chassis, said extension framework having a first and a second end, said extension extending from said chassis in said second direction;
a mixer container supported by said extension such that said container is disposed between said chassis and said second end of said extension; and
at least one steerable wheel rotatably connected to said extension such that location and positioning of said mixer container for dispensing the livestock feed is enhanced.

2. A combined chassis and mixer apparatus as set forth in claim 1 wherein
said drive wheels have a diameter which is greater than a diameter of said steerable wheel.

3. A combined chassis and mixer apparatus as set forth in claim 1 wherein
said chassis is a tractor that has had a front steering axle removed therefrom;
said first end of said extension being rigidly secured to said tractor.

4. A combined chassis and mixer apparatus as set forth in claim 1 wherein
said mixer container is secured to said extension.

5. A combined chassis and mixer apparatus as set forth in claim 1 wherein
said mixer container includes:
a base which defines a peripheral edge;
a wall extending away from said peripheral edge, said base and said wall defining therebetween an enclosure for the reception therein of the livestock feed;
an auger rotatably disposed within said enclosure such that when the feed is disposed within said enclosure, rotation of said auger mixes the livestock feed.

6. A combined chassis and mixer apparatus as set forth in claim 5 further including:
a power take off driveline extending between said gearbox and said auger for rotating said auger.

7. A combined chassis and mixer apparatus as set forth in claim 5 wherein
said wall defines a discharge outlet for the discharge therethrough of mixed livestock feed.

8. A combined chassis and mixer apparatus as set forth in claim 1 wherein
said steerable wheel is a multiple wheel.

9. A combined chassis and mixer apparatus as set forth in claim 5 further including:
a power take off driveline extending between said gearbox and said auger for rotating said auger.

10. A combined chassis and mixer apparatus for mixing livestock feed, said apparatus comprising:
a chassis having a front and a rearward end;
said chassis including:
an operator station;
a motor;
a gearbox driven by said motor;
a pair of drive wheels for moving said chassis, said drive wheels being connected to said gearbox for selectively moving said chassis in a first direction from said rearward end towards said front end and in a second direction from said front end towards said rearward end of said chassis;
an extension framework having a first and a second end, said extension extending from said chassis in said second direction;
a mixer container supported by said extension such that said container is disposed between said chassis and said second end of said extension;
at least one steerable wheel rotatably connected to said extension such that location and positioning of said mixer container for dispensing the livestock feed is enhanced; and
said apparatus further including:
a self loader arrangement for collecting and conveying material to said container.

11. A combined chassis and mixer apparatus as set forth in claim 10 wherein
said self loader arrangement includes:
a bucket;
a first and a second auger disposed within said bucket for collecting the material;
a conveyor having a first and a second end, said first end being disposed adjacent to said bucket, said second end of said conveyor being disposed above said container for conveying the material from said augers to said container.

12. A combined chassis and mixer apparatus as set forth in claim 11 wherein
said conveyor is pivotally mounted about a pivotal axis disposed between said first and second ends of said conveyor for permitting an operator to alter the elevation of said bucket.

13. A combined chassis and mixer apparatus as set forth in claim 10 wherein
said steerable wheel includes:
a first and a second wheel.

14. A combined chassis and mixer apparatus as set forth in claim 10 wherein
said steerable wheel includes:
a single wheel;
a tire mounted on said wheel, said tire having a narrow steer wheel tread.
